(19) United States
(12) Patent Application Publication
(10) Pub. No.: US 2024/0425316 A1
(43) Pub. Date: Dec. 26, 2024

(54) Computer Implemented Method for Controlling a Winding Machine and for Training a Machine Learning Algorithm, Computer Program and Winding Machine

(71) Applicant: Siemens Aktiengesellschaft, Muenchen (DE)

(72) Inventors: Vladimir LAVRIK, Dreiech (DE); Georgia ATHANASIOU, Nürnberg (DE); Sebastian KERLING, Erlangen (DE); Uwe KRAUTER, Erlangen (DE)

(21) Appl. No.: 18/749,317

(22) Filed: Jun. 20, 2024

(30) Foreign Application Priority Data
Jun. 23, 2023 (EP) 23181206

(51) Int. Cl. B65H 26/04; B65H 18/08; G06N 20/00

(52) U.S. Cl. CPC B65H 26/04; B65H 18/08; G06N 20/00; B65H 2513/10; B65H 2515/31

(57) ABSTRACT

A computer implemented method for controlling a winding machine, wherein the winding machine includes at least a winder and a rewinder, and wherein the method includes determining the actual velocity of the winder during operation of the winding machine, performing signal processing of the determined actual velocity to extract a winder-related feature, where the signal processing includes subtracting a command velocity from the determined actual velocity, determining an envelope signal of a subtracted signal and filtering the envelope signal to preserve amplitude-related information, the method further includes using the filtered envelope signal as a winder-related feature and an as input for a trained machine learning algorithm, and executing the machine learning algorithm based on the winder-related feature and issuing an anomaly indicator as an output.

### BACKGROUND OF THE INVENTION

### 1. Field of the Invention

The invention relates to a computer implemented method for controlling a winding machine, a computer implemented method for training a machine learning algorithm, a corresponding computer program and a winding machine.

### 2. Description of the Related Art

Winding machines are installed in various applications relating to the paper, textile, or battery industry. A winding machine enables a web of different types of materials to be wound around a target object. It is of utmost importance to make sure the web is wound tightly to guarantee a high quality of the winded component. For that purpose, complex control schemes have been developed for winding machines.

A wide variety of parameters, such as friction or temperature, influence the web velocity which is compensated by the winding machine control mechanism. However, anomalies of low amplitude may appear in the web tension and oftentimes (depending on the type of material of a web as well as the amplitude of a web tension variation) either are detected at product quality inspection process or remain undetected. The product quality in both cases is affected, and either the defect is detected late in the process so that a product has to be sorted out or not detected at all, which can even cause safety issues.

Highly automated winding machines along with control schemes are known to assure that a web is tightly wound around the object. For controlling the winding quality, different means of manual inspection have been employed. A visual inspection is known, and in cases where the amplitude of an anomaly in the applied web tension is quite high, it can be inspected through visual inspection by experienced operators. Apart from an anomality amplitude, the success of such a method is also a matter of the material wound up. It is, for example, quite straightforward for an experienced operator to determine whether paper is wound tightly, while it requires additional effort when the web material is coil or wire. The same is the case when the anomaly occurs in lower layers of the wound web and additional layers are wound before the visual inspection takes place.

Moreover, a manual analysis of a spectrogram is known for manual inspection. Here, an operator monitors a spectrogram produced analyzing a signal from a rewinder in an online mode. The interpretation of calculated spectrograms again requires significant experience in case it is performed manually. A spectrogram is produced by short time Fourier transform of a signal acquired from a dancer. For example, spectrograms produced by short time Fourier transformation of a signal acquired from a dancer, e.g., a dancer deviation from a setpoint, are used and must be interpreted. The advantage of such a method is that the quality control is performed online and the winding process can be stopped by an operator if additional frequencies are presented on a spectrogram and therefore an abnormality is presumed.

### SUMMARY OF THE INVENTION

In view of the above-described drawbacks associated with the state-of-the-art, it is therefore an object of the invention to provide a computer implemented method for controlling a winding machine and for training a machine learning algorithm with an automated anomaly detection, a corresponding computer program and a corresponding winding machine.

These and other objects and advantages are achieved in accordance with the invention by a computer implemented method for controlling a winding machine, where the winding machine comprising at least a winder and a rewinder, and where the method comprising determining an actual velocity of the winder during operation of the winding machine, performing a signal processing of the determined actual velocity to extract a winder-related feature, where the signal processing comprises subtracting a command velocity from the determined actual velocity, determining an envelope signal of the subtracted signal, and filtering the envelope signal, and where the filtering preserves amplitude-related information. The method additionally comprises using the filtered envelope signal as a winder-related feature and as an input for a trained machine learning algorithm, and executing the machine learning algorithm based on the winder-related feature and issuing an anomaly indicator as an output.

A winding machine can be used for any kind of material to be wound up or any web, such as paper, foil, textile web or similar. Moreover, the target object, upon which the web is wound, can be of round, prismatic, triangular or rectangular shape. For all these specialized winding machines, it is essential to guarantee a constant web tension as far as possible. As soon as a web tension is not in a specified given range depending on the concrete apparatus and configuration, the web is wound irregularly and the wound product is of poor quality.

Therefore, different kind of compensation mechanisms are known for winding machines to allow a control of the web tension. Also, different kinds of components are commonly used to introduce changes into the system or to amend parameters accordingly, such as in specific dancers or web accumulators or load cells.

In accordance with the invention, the signal of the actual velocity of the winder is analyzed, whereas the winder is the component from which the web is provided for the rewinder coil, via a machine learning algorithm. The signal of the actual velocity of the winder processed in the right manner, is rich of information for differentiating between healthy and unhealthy winding states. The machine learning approach for analyzing the winder signal works in either a supervised or an unsupervised setting and either live, i.e., during operation of the winding machine and during the winding process, or post-mortem.

The establishment of an anomaly detection method is based on selecting signals of rich information content that can indicate whether an anomaly occurs at the given time period being under investigation or not. This is achieved by the utilization of the following signals: the signal of the actual velocity of the winder and of a command velocity.

A process of features extraction occurs, which includes the steps of signal processing. In that way, signals are transformed and features are extracted, which include information that can be correlated with an emergence of an anomaly. Especially the actual and command velocity of the winder are processed together for the sake of feature extraction, as follows:

A positive and/or negative offset of the signal is removed if applicable.

The signal of the winder command velocity is subtracted from that of the actual velocity. The resulting signal is utilized to determine a corresponding envelope signal. The envelope signal is filtered such that information concerning the amplitude of the envelope signal is preserved. For example, low-pass filtering of a short transition phase is used such as butterworth, chebychev, Bessel of high order, preferably 3rd order and higher, depending on the noise of the signal. By using a suitable filtering method, any disturbances or spikes or noise is filtered out, preserving at the same time any amplitude related information of the signal.

The processed signal is utilized as a winder-related feature and input into an unsupervised or supervised machine learning algorithm. An unsupervised machine learning algorithm indicates that an anomaly has emerged. A supervised machine learning algorithm indicates whether the under-investigation process at a given time window is of low or high quality.

In an advantageous embodiment, a machine learning (ML) based scheme is provided that enables the detection of anomalies of a web tension by measuring and analyzing winding machine process parameters without need of an additional sensor.

In an advantageous manner, a skilled person that must perform an inspection of the winded up material manual and in a postmortem manner is not necessary. This also reduces unnecessary waste of a material or rework efforts.

Furthermore, the described approach compared to well-known semi-automated analysis based on spectrogram calculations requires no experience-based interpretation process.

The fully automated proposed solution is useful for the entire range of materials and operational conditions for online quality control of a winding process. This also qualifies the method for usage in mass-production with post-mortem-quality assurance across all produced units in a certain area.

In accordance with an embodiment, the method further comprises initiating an amendment of at least one control parameter of the winding machine in the event of an indicated anomaly. With the machine learning algorithm detecting anomalies, parameters of the winding machine, such as a dancer, can be adjusted to keep the quality of a product as high as possible.

With the machine learning algorithm in place, an anomaly detector is realized that outputs certain anomaly scores, which are translated into parameters of the control system to reset reference values of certain components of the winding machine, such as the winder or the dancer, in order to keep a quality of a product acceptable.

With the feedback of the output of the machine learning algorithm back to the control system, the winding process is improved as the web tension is kept more stable.

In accordance with another embodiment, the winding machine further comprises a web accumulator, and a web-accumulator-related feature is extracted from the web accumulator actual position and is used as an additional input for the trained machine learning algorithm and the machine learning algorithm is executed based on the winder-related feature and the web-accumulator-related feature.

In an advantageous manner, in winding machines, where a web-accumulator is used, signals and features relating to the web-accumulator are also used to extract more or better information or information at an earlier point in time regarding an anomaly in the winding process. Using the processed signal of the actual position of the web-accumulator in addition to the processed signal of the difference of actual and command velocity makes the machine learning algorithm more robust.

A web accumulator is a system based on linear motor, where the operation seeks to calibrate disturbance behavior on web tension in a controlled way. However, in cases where the emerged anomalies are quite unexpected, difficult to be captured by reference signals or of short duration, web accumulator operation is less than effective. In such cases, anomalies are expressed on the web accumulator position which diverts from a balancing point due to high speed or torque of anomalous behaved web. Thus, the information content inheriting such a position signal is quite rich.

In accordance with an embodiment, the web-accumulator-related feature is built based on a peak-to-peak value of the web accumulator actual position within a specified time window.

The feature of peak-to-peak of the web accumulator actual position in a specified, e.g., user defined, time window is used and further processed via statistical filtering. For example, statistical-based filtering methods such as median, e.g., as median filter of a window size of preferably five, is used. The utilization of a statistically filtered peak-to-peak feature not only shows diversion on amplitude, i.e., diverting behavior, but also fluctuations related to short-term variations. This permits the capture of short amplitude fluctuation as well as the detection of time-evolving amplitude anomalies.

In accordance with a further embodiment, the time window is specified by a period of the signal of the web-accumulator actual position. The period and therefore the time window is, for example, known for a specific winding machine setup and defined by an operator after an initial setup phase. Alternatively, the time window is determined by the system automatically based on an identified period.

In accordance with an embodiment, the winding machine further comprises a dancer, and a dancer-related feature is extracted from the dancer actual position and is used as additional input for the trained machine learning algorithm and the machine learning algorithm is executed based on the winder-related feature and the dancer-related feature or the winder-related feature, the web-accumulator-related feature and the dancer-related feature.

In a winding machine setup, where a dancer is used, a feature extraction from a dancer-related signal is also performed and used in addition to the winder-related feature extraction to make the machine learning algorithm more robust. If a web accumulator as well as a dancer are in place, then even feature extraction from all three signals, winder, web accumulator and dancer, can be used to feed the machine learning algorithm.

In accordance with another embodiment, the dancer-related feature is built based on a waveform shape of the dancer actual position, in particular based on the crest factor of signal of the dancer related actual position, within a specified time window. Structural alterations of the waveform shape can be exploited to gain information regarding the dancer health status and therefrom draw conclusions about the overall systems health status.

In accordance with a further embodiment, the machine learning algorithm has been trained based on a supervised training method. Suitable supervised learning techniques for anomalies detection are k-nearest neighbors algorithms (KNN) with, e.g., k=5 or k=7, or methods based on logistic regression and decision tree, in particular of non-random partition.

In accordance with an embodiment, the machine learning algorithm has been trained based on an unsupervised training method. For unsupervised training methods, the extracted features are introduced without additional information and clusters are created by the algorithm, for example, using a k-means approach. For example, k-means algorithms with k=2 or k=3 or fuzzy-c-means algorithms are used.

The objects and advantages in accordance with the invention are also achieved by a computer implemented method for training a machine learning algorithm, where the machine learning algorithm issues an anomaly indicator as an output for controlling a winding machine and initiates an amendment of at least one control parameter of the winding machine in case of an indicated anomaly, and where the winding machine comprises at least a winder and a rewinder, and the method comprises determining an actual velocity of the winder during operation of the winding machine, performing signal processing of the determined actual velocity in order to extract a winder-related feature, where the signal processing comprises subtracting a command velocity from the determined actual velocity, determining an envelope signal of the subtracted signal, and filtering the envelope signal, where the filtering preserves an amplitude-related information, The method additionally includes using the filtered envelope signal as a winder-related feature, and training the machine learning algorithm based on the winder-related feature.

In accordance with an embodiment, an unsupervised training method is used to identify clusters and determine an anomaly degree for input data based on a corresponding cluster.

In accordance with a further embodiment, a supervised training method is used to identify classes based on labeled training data sets and to determine an anomaly degree for input data based on a corresponding class.

In case of a supervised learning approach, whether web tension during operation is healthy or exceeds the threshold of normal behavior must be estimated. This can be achieved if the web tension is measured and can be classified in healthy and anomalous operation states. Those states associated with the training data sets are used as label in the training phase of the machine learning algorithm.

In an embodiment, the winding machine in a training phase comprises a web tension sensor, where labeled data is generated depending on values of the web tension sensor.

Within the context of the given investigation, a sensor has been introduced into winding machine that measures the web tension in real time. After signal processing, the amplitude of web tension constitutes information that can be effectively utilized as labelling corresponding training data sets.

The objects and advantages in accordance with invention are further achieved by a computer program having instructions which, when executed by a computing device or system, cause the computing device or system to perform the method in accordance with the disclosed embodiments.

The objects and advantages are furthermore achieved in accordance with the invention by a winding machine with a data-processing system comprising at least one processor and memory for implementing the method in accordance with the disclosed the embodiments of the method. The data-processing system, for example, is integrated into a controller for controlling the winding machine. The controller in particular controls the axes or corresponding drives of the different rolls depending on the implementation of the winding machine.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the following different aspects of the present invention are described in more detail with reference to the accompanying figures, in which:

FIG. 1 shows a schematic diagram of winder-related curves of actual and command velocity in accordance with a first embodiment of the present invention;

FIG. 2 shows a schematic diagram of processed winder-related curves offset-corrected in accordance with the first embodiment of the present invention;

FIG. 3 shows a schematic diagram of further processed winder-related curves of winder command velocity subtracted by winder actual velocity in accordance with the first embodiment of the present invention;

FIG. 4 shows a schematic diagram of the filtered envelope signal extracted as winder-related feature in accordance with the first embodiment of the present invention;

FIG. 5 shows a schematic diagram of the distribution of amplitudes of the actual velocity of the winder in healthy and different unhealthy operations in accordance with the first embodiment of the present invention;

FIG. 6 shows a schematic drawing of a winding machine in accordance with a second embodiment of the present invention;

FIG. 7 shows a schematic diagram of different signal-processed web accumulator-related curves in accordance with the second embodiment of the present invention;

FIG. 8 shows schematic box plots of a web-accumulator-related feature in accordance with the second embodiment of the present invention,

FIG. 9 shows a schematic drawing of a control mechanism for a winding machine in accordance with a third embodiment of the present invention;

FIG. 10 shows a schematic diagram of dancer-related curves in accordance with a fourth embodiment of the present invention;

FIG. 11 shows a zoom-in of the curve shown in FIG. 10 at a first time window during a healthy operation;

FIG. 12 shows a zoom-in of the curve shown in FIG. 10 at a second time window during an unhealthy operation;

FIG. 13 shows a zoom-in of the curve shown in FIG. 10 at a third time window during a further unhealthy operation;

FIG. 14 is a flowchart of the method in accordance with a first embodiment of the present invention; and

FIG. 15 is a flowchart of the method in accordance with a second embodiment of the present invention;

### DETAILED DESCRIPTION OF THE EXEMPLARY EMBODIMENT

For a first embodiment of the invention, a winding machine is equipped with a machine learning algorithm that evaluates whether a winding process winding up a web, e.g., a coil for a battery cell, from a winder, e.g., a round object, to a rewinder, e.g. a rectangular target object, is performed without disturbances that would lead to a bad quality of the battery cell. It is particularly very important to guarantee that a regular web tension is applied to the web during coiling to ensure there are no irregularities in the product, which might lead to damage of the battery. The machine learning algorithm analyzes the winding process based on winder-related features, which are extracted from the winding process parameters without additional sensors. As an output, the machine learning algorithm gives an indication, whether the winding process is in a healthy condition or whether there are indicators for an unhealthy condition.

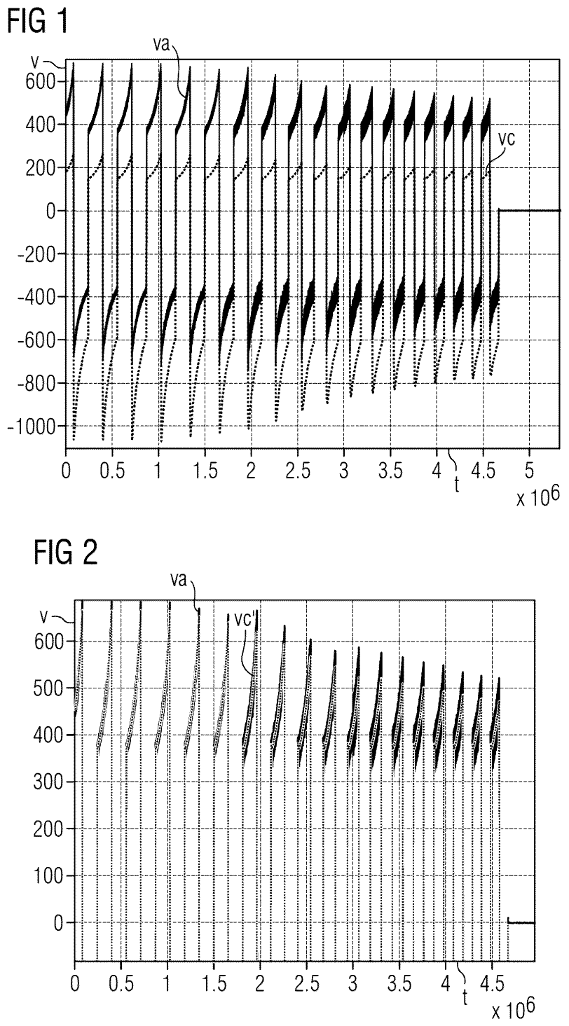

FIG. 1 shows two speed signals v, the signal of the actual velocity of the winder va in mm/ms plotted over the time in ms. Only the parts of a repetitive forward movement of the winder are shown, the velocity of the movement in the timespan in between has been eliminated for purposes of clarity.

In addition, the command velocity vc is shown in the same units.

In the diagram shown in FIG. 2, some signal processing has been performed and the command velocity vc of FIG. 1 now has been corrected by an offset to turn into an offset-corrected command velocity vc′ plotted over time. The same signal of the actual velocity va of the winder than in FIG. 1 is also plotted in FIG. 2 for comparison.

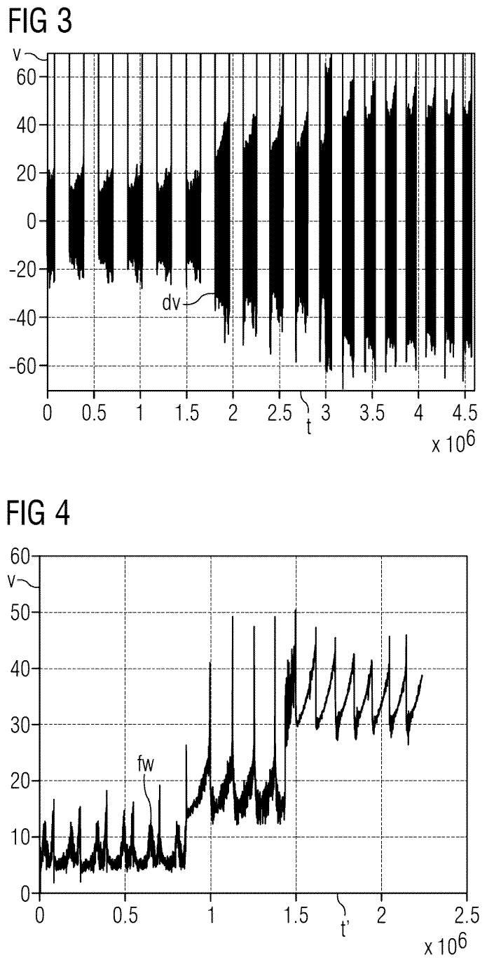

In a next step, the actual velocity va is subtracted from the offset-corrected command velocity vc′ and the subtracted signal dv is shown in FIG. 3 and plotted again over time in the same units as in the figures before.

As a next step, an envelope signal is determined that envelopes the subtracted signal dv. This envelope signal is furthermore filtered with a filtering algorithm that preserves the amplitude information and eliminates noise. A Butterworth algorithm of 3rd order has been applied in the first embodiment. The filtered envelope signal is used as a winder-related feature fw that is extracted from process parameters of the winding process and is shown in FIG. 4.

The winder-related feature fw is supplied to the machine learning algorithm. As an output, the machine learning algorithm in accordance with the first embodiments provides an indicator, whether the winding process in a given time window has been performed under normal conditions, so that no unhealthy status of the winding machine is expected, or whether there are hints that a type of disturbance occurred. In supervised machine learning algorithms, different degrees or types of disturbance, e.g., belonging to different sources for irregularities in the web tension, can be trained with respectively labeled training data sets.

FIG. 4 shows the filtered envelope signal fw in three different states of operation, a healthy state in the time period from 0-0,8 x106 ms, a state with a first introduced disturbance from 0,8-1,45 x106 ms and a state with a second introduced disturbance from 1,45-2,25 x106 ms. The second disturbance in this embodiment was an additional disturbance that occurred after the first disturbance already had occurred or a disturbance posed on the already existing one.

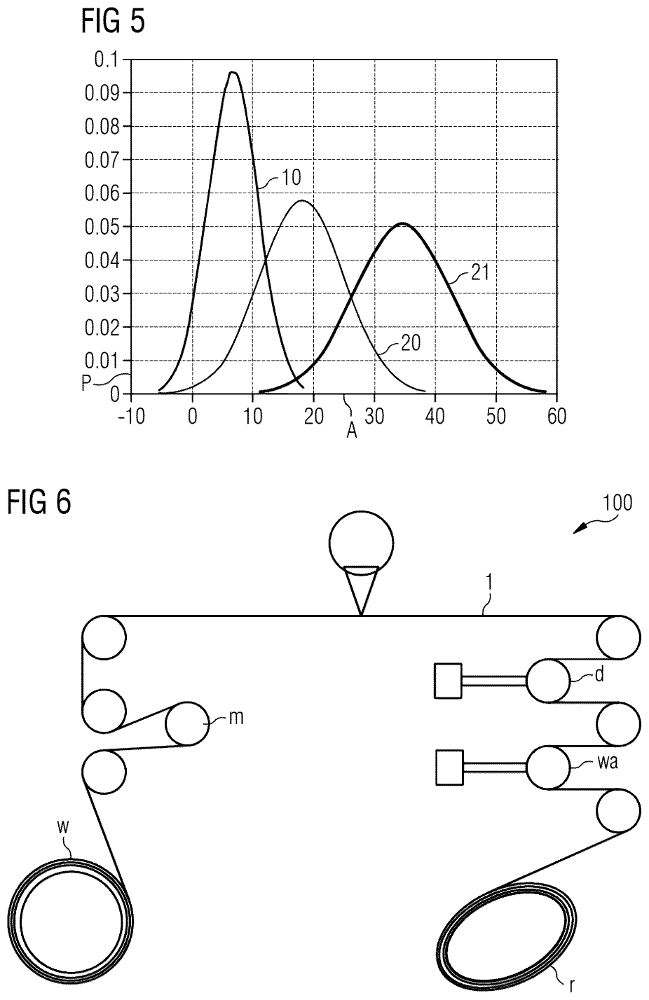

FIG. 5 illustrates the distribution of amplitudes of the actual velocity va of the winder being relatively sharp centered around a specific amplitude for a healthy state 10 and being more smeared for unhealthy states 20, 21.

In a second embodiment, a winding process is assisted by a machine learning algorithm that not only takes into account a winder-related feature fw, but also a feature extracted from a web-accumulator. FIG. 6 shows a typical structure of a winding machine with winder w and a rewinder r.

A winding machine is a fully automated system enabling a web 1 of material, e.g., a textile web in accordance with the second embodiment of the invention, to be winded around a target object. As shown in FIG. 6, this is achieved by a system of freely or controlled rotors. Especially, the winder w is provided as a starting point at which the web is stored that is about to be wound. On the opposite site, the rewinder r is provided for receiving the web as the target object. The target object in this embodiment is of prismatic shape.

Both winder w and rewinder r are moving in a controlled way so as to wind the web tightly. For that purpose, two linear motors are deployed driving a dancer d and a web accumulator wa enabling web speed, torque and position to be calibrated in accordance with a provided control scheme. In such a control system, the mechanical system of master axis m is utilized to provide reference information regarding the web position and speed.

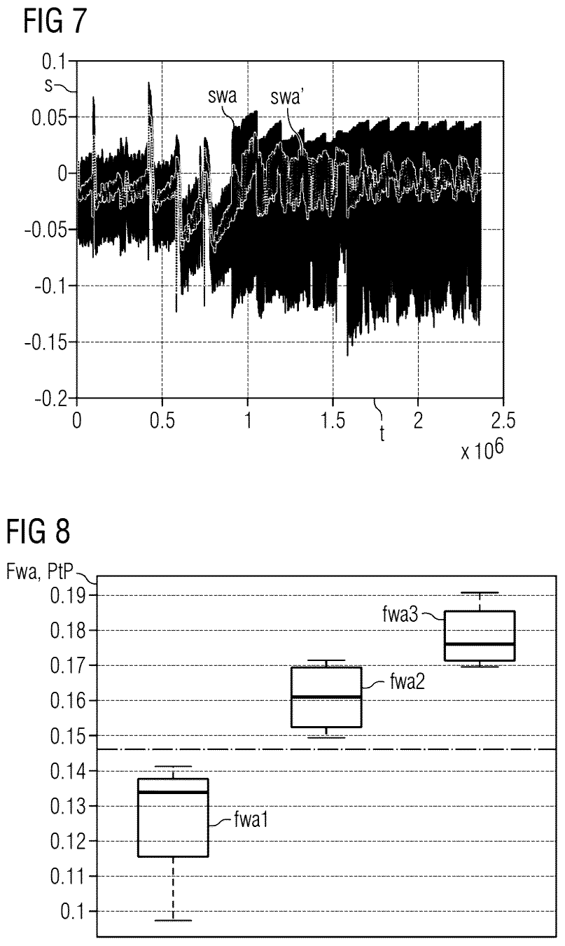

To utilize a web-accumulator-related feature as an input for the machine learning algorithm, the signal of the actual position of the web-accumulator is analyzed. FIG. 7 shows the signal swa of the web-accumulator actual position s plotted over the time t. The web-accumulator actual position signal swa is filtered to eliminate noise and other anomalies. The resulting filtered signal swa′ is processed to extract a peak-to-peak value PtP of the signal in a specified time window.

In FIG. 8, box plots of different peak-to-peak values PtP of the filtered web-accumulator actual position signal are shown. A first peak-to-peak value 10 is derived for the web-accumulator actual position signal swa during a time span in which the winding process is performed under normal or healthy conditions. Within that time span of normal conditions, the peak-to-peak value PtP is derived from the signal within a specified time window. The suitable time window to choose is dependent from the actual web-accumulator position signals swa period, where a period is formed by the compensation movement of the web-accumulator for compensating irregularities in the web tension. A second and third peak-to-peak value 20, 21 is derived for the web-accumulator actual position signal swa during different time spans in which the winding process is performed under unnormal or unhealthy conditions.

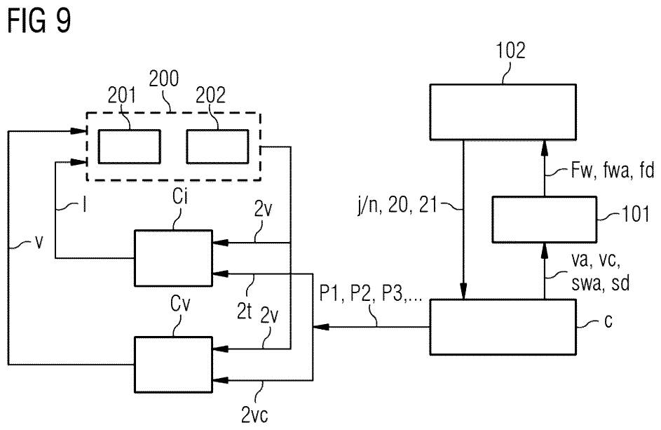

FIG. 9 provides a scheme for a control mechanism underlying a winding machine or used in a winding process. An anomaly detector 102 is provided that works based on the extracted features fw, fwa, fd that are described above or in the following and that are extracted by a feature analyzer 101 based on the various process parameters derivable from the winding machine process control system. As an output, the anomaly detector issues an anomaly indicator j/n indicating whether the winding process is performed under normal or unnormal conditions. Together with the anomaly indicator j/n, additional information is preferably provided to the control system C of the winding machine, which has been derived in a training phase of the machine learning algorithm and which allow a translation into parameters of the control system. For example, anomaly scores or anomaly degrees 20, 21 are derivable for which suitable reference values of control parameters P1, P2, P3, . . . of the winding control system have been derived in the training phase.

In an advantageous manner, the control mechanism is enriched by information about how to best adapt control parameters in case of a specific unhealthy state of the winding machine. For example, the drive system 200 of the rewinder comprising a rewinder motor 201 and a load 202 gives values of the actual speed 2v to a current controller Ci and a speed controller Cv and with an additional torque value 2t and a speed setpoint value 2vc, both influenced by the reference values of control parameters, P1, P2, P3, . . . the current controller Ci and the speed controller Cv can provide current I and speed V as correcting variables to the drive system 200.

The anomaly detector, for example, is implemented on an Industrial Edge system or an industry PC with connection to a web application for training purposes.

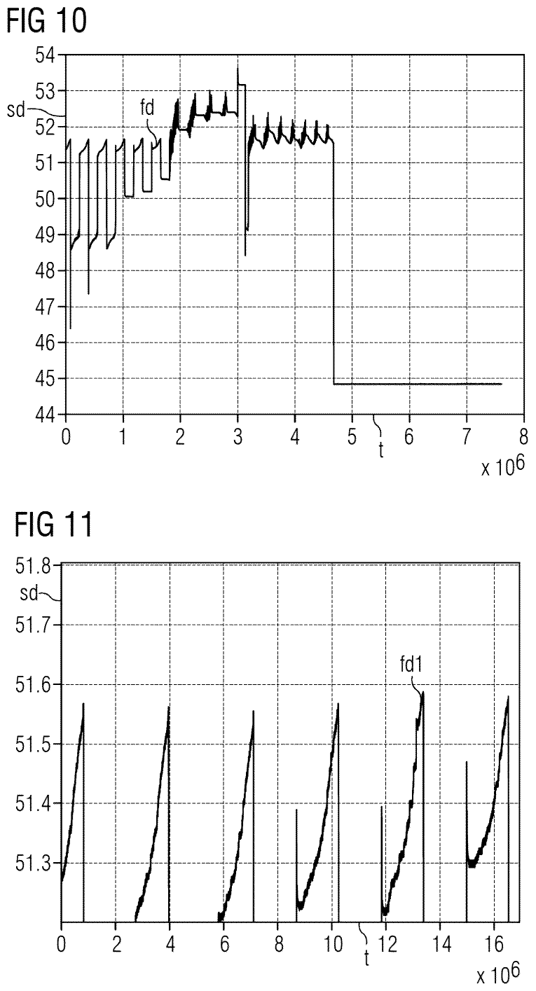

FIG. 10 illustrates a feature extraction in a winding process according to a fourth embodiment of the invention. Here, not only input parameters of a winder of a winding machine are used for the purpose of anomaly detection, but also a dancer and the behavior of the dancer during coiling are examined. Therefore, the signal of the dancer actual position sd is determined and logged over the time t.

As evident from FIG. 10, the waveform shape fd of the signal of the dancer actual position sd has three different characteristic forms. The details of the first waveform shape fd1 is shown in more detail in FIG. 11 and zooms into the respective signal in FIG. 10. Each rising edge belongs to an up-winding process in a winding program with repetitive up- and unwinding (only up-winding or forward movement is shown).

The signal of the dancer actual position with the waveform shape fd1 indicates a normal behavior. As long as the machine learning algorithm obtains such a waveform shape fd1 as an input, no disturbance or anomaly is indicated.

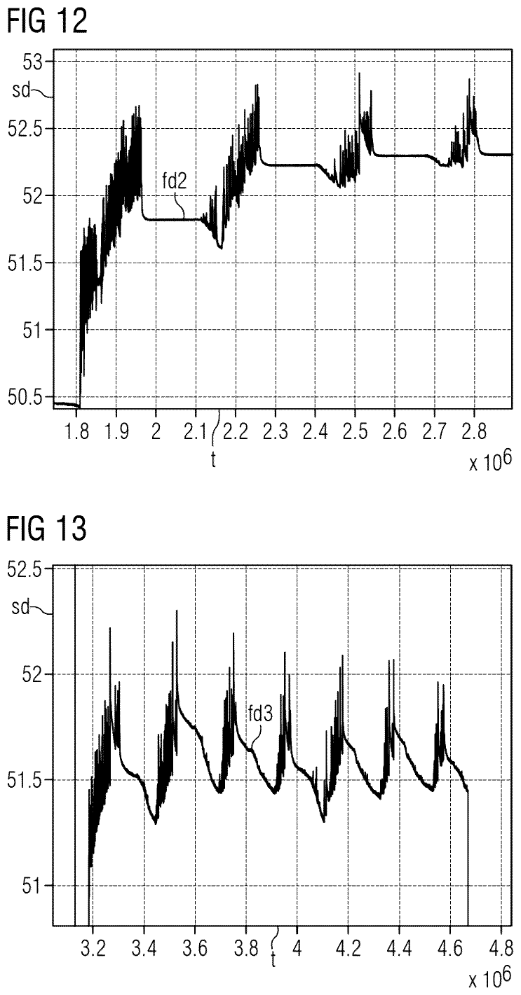

In FIG. 12, the waveform shape fd2 is shown in more detail. The waveform shape fd2 varies widely from the waveform shape fd1, which makes the signal in particular valuable for the machine learning algorithm. The machine learning algorithm operates particularly well with several extracted features as input, e.g., a winder-related feature, a dancer-related feature, and optionally in addition a web-accumulator related feature. Considering those different extracted features transforms the machine-learning algorithm into a more robust system, and allows a reliably anomaly detection also in cases, where one of the components delivers erroneous or misleading values, which for example differ too much from the values generated and collected during the training phase as training data.

For further illustration, FIG. 13 shows the waveform shape fd3 in more detail. The waveform shape fd3 again is of clearly different form as the waveform shapes fd1 and fd2. It is, for example, caused by a different kind of disturbance and indicates a specific kind of anomaly, expressed for example via a different anomaly score or anomaly degree 21 than the anomaly degree 20 in case of the waveform shape fd2. For example, an anomaly score is expressed via a percentage information.

In advantageous embodiments, each anomaly score is related to a set of parameters, which is provided as feedback to the control mechanism for adjustment of the controller. For example, a winder velocity or a force or counterforce of the dancer is adjusted in accordance with the reference values from the design phase or training phase.

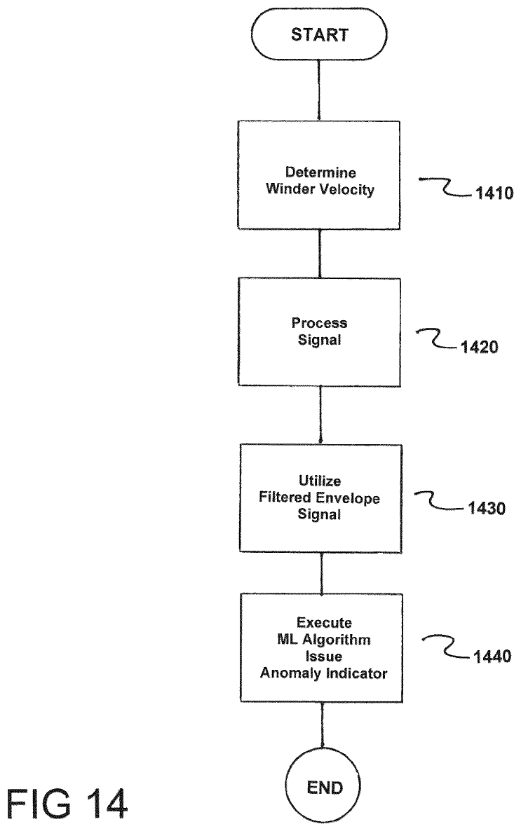

FIG. 14 is a flowchart of the computer implemented method for controlling a winding machine 100 in accordance with a first embodiment of the invention, where the winding machine comprises at least a winder w and a rewinder r.

The method comprises determining an actual velocity va of the winder w during operation of the winding machine 100, as indicated in step 1410.

Next, signal processing of the determined actual velocity va to extract a winder-related feature fw is performed, as indicated in step 1420. In accordance with the invention, the signal processing comprises subtracting a command velocity vc, vc′ of the winder from the determined actual velocity va, determining an envelope signal of a subtracted signal dv, and filtering the envelope signal, where the filtering preserves amplitude-related information.

Next, the filtered envelope signal is used as a winder related feature fw and as an input for a trained machine learning algorithm, as indicated in step 1430.

Next, the machine learning algorithm is executed based on the winder-related feature fw and an anomaly indicator j/n is issued as an output, as indicated in step 1440.

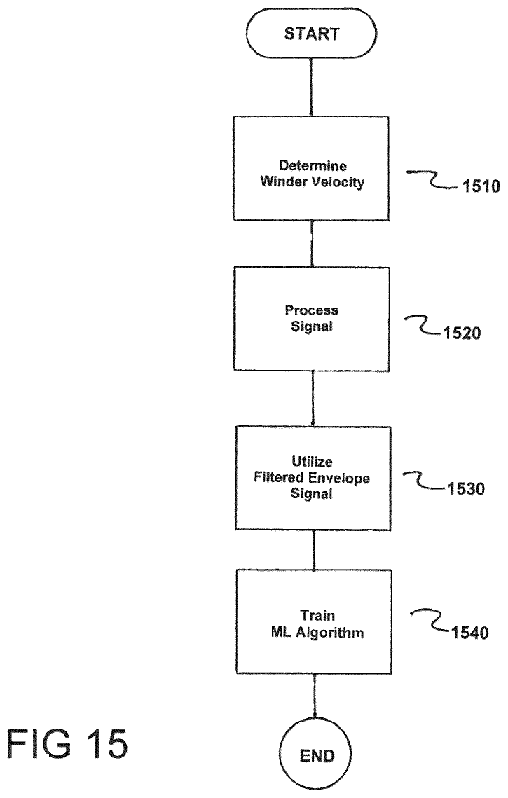

FIG. 15 is a flowchart of the computer implemented method for training a machine learning algorithm that provides an anomaly indicator as an output for controlling a winding machine 100 and that initiates an amendment of at least one control parameter P1, P2, P3, . . . of the winding machine 100 in the event of an indicated anomaly, where the winding machine 100 comprises at least a winder w and a rewinder r.

The method comprises determining an actual velocity va of the winder w during operation of the winding machine 100, as indicated in step 1510.

Next, signal processing of the determined actual velocity vs is performed to extract a winder-related feature fw, as indicated in step 1520. In accordance with the invention, the signal processing comprises subtracting a command velocity vc, vc′ from the determined actual velocity va, determining an envelope signal of a subtracted signal dv, and filtering the envelope signal, where the filtering preserves an amplitude-related information.

Next, the filtered envelope signal is used as a winder related feature fw, as indicated in step 1530.

Next, the machine learning algorithm is trained based on the winder-related feature fw, as indicated in step 1540.

Further possible implementations or alternative solutions of the invention also encompass combinations (that are not explicitly mentioned herein) of features described above or below with regard to the embodiments. The person skilled in the art may also add individual or isolated aspects and features to the most basic form of the invention.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer implemented method for controlling a winding machine, the winding machine comprising at least a winder and a rewinder, the method comprising:
determining an actual velocity of the winder during operation of the winding machine;
performing signal processing of the determined actual velocity to extract a winder-related feature, said signal processing comprising subtracting a command velocity of the winder from the determined actual velocity, determining an envelope signal of a subtracted signal, and filtering the envelope signal, the filtering preserving an amplitude-related information;
utilizing the filtered envelope signal as a winder-related feature and as an input for a trained machine learning algorithm; and
executing the machine learning algorithm based on the winder-related feature and issuing an anomaly indicator as an output.

2. The method according to claim 1, further comprising:
initiating an amendment of at least one control parameter of the winding machine in an event of an indicated anomaly.

3. The method according to claim 1, wherein the winding machine further comprises a web accumulator, and a web-accumulator-related feature is extracted from the web accumulator actual position and is utilized as an additional input for the trained machine learning algorithm and the machine learning algorithm is executed based on the winder-related feature and the web-accumulator-related feature.

4. The method according to claim 2, wherein the winding machine further comprises a web accumulator, and a web-accumulator-related feature is extracted from the web accumulator actual position and is utilized as an additional input for the trained machine learning algorithm and the machine learning algorithm is executed based on the winder-related feature and the web-accumulator-related feature.

5. The method according to claim 3, wherein the web-accumulator-related feature is built based on a peak-to-peak value of the web accumulator actual position within a specified time window.

6. The method according to claim 5, wherein the time window is specified by a period of the signal of the web-accumulator actual position.

7. The method according to claim 6, wherein the winding machine further comprises a dancer, and a dancer-related feature is extracted from the dancer actual position and is utilized as an additional input for the trained machine learning algorithm and the machine learning algorithm is executed based on one of (i) the winder-related feature and the dancer-related feature and (ii) the winder-related feature, the web-accumulator-related feature and the dancer-related feature.

8. The method according to claim 6, wherein the dancer-related feature is built based on a waveform shape of the dancer actual position.

9. The method according to claim 8, wherein the dancer-related feature comprises a crest factor of the signal of the dancer related actual position within a specified time window.

10. The method according to claim 1, wherein the machine learning algorithm is pre-trained based on a supervised training method.

11. The method according to claim 1, wherein the machine learning algorithm is pre-trained based on an unsupervised training method.

12. A computer implemented method for training a machine learning algorithm which provides an anomaly indicator as an output for controlling a winding machine and which initiates an amendment of at least one control parameter of the winding machine in an event of an indicated anomaly, and the winding machine comprising at least a winder and a rewinder, the method comprising:
determining an actual velocity of the winder during operation of the winding machine;
performing signal processing of the determined actual velocity to extract a winder-related feature, said signal processing comprising subtracting a command velocity from the determined actual velocity, determining an envelope signal of a subtracted signal, and filtering the envelope signal, the filtering preserving an amplitude-related information;
utilizing the filtered envelope signal as winder-related feature; and
training the machine learning algorithm based on the winder-related feature.

13. The method according to claim 12, wherein an unsupervised training method is utilized to identify clusters and to determine an anomaly degree for input data based on a corresponding cluster.

14. The method according to claim 12, wherein a supervised training method is utilizing to identify classes based on labeled training data sets and to determine an anomaly degree for input data based on a corresponding class.

15. The method according to claim 14, wherein the winding machine in a training phase comprises a web tension sensor; and wherein labeled data is generated depending on values of the web tension sensor.

16. A computer program having instructions which when executed by a computing device or system cause the computing device or system to perform the method according to claim 1.

17. A winding machine comprising:
a data-processing system including a processor and memory;
wherein the processor is configured to:
determine an actual velocity of the winder during operation of the winding machine;
perform signal processing of the determined actual velocity to extract a winder-related feature, said signal processing comprising subtracting a command velocity of the winder from the determined actual velocity, determining an envelope signal of a subtracted signal, and filtering the envelope signal, the filtering preserving an amplitude-related information;
utilize the filtered envelope signal as a winder-related feature and as an input for a trained machine learning algorithm; and
execute the machine learning algorithm based on the winder-related feature and issue an anomaly indicator as an output.
